(19) United States
(12) Patent Application Publication
(10) Pub. No.: US 2016/0099772 A1
(43) Pub. Date: Apr. 7, 2016

(54) SYSTEMS AND METHODS FOR DETECTION OF INTRUSION IN OPTICAL FIBER

(71) Applicant: Compass Electro Optical Systems Ltd., Netanya (IL)

(72) Inventors: Michael MESH, Kfar Saba (IL); Alexander ZELTSER, Netanya (IL)

(21) Appl. No.: 14/877,811

(22) Filed: Oct. 7, 2015

Related U.S. Application Data
(60) Provisional application No. 62/060,942, filed on Oct. 7, 2014.

(51) Int. Cl. H04B 10/07; H04B 10/079

(52) U.S. Cl. CPC H04B 10/0705; H04B 10/07955

(57) ABSTRACT

Techniques for detecting intrusion in an optical fiber can be realized as a method comprising: receiving an optical signal; demultiplexing the received optical signal into one or more payload data signals, a first control signal, and a second control signal; comparing a ratio of power levels of the first and second control signals with a threshold ratio; comparing the power level of the control first signal with a first threshold power value and the second control signal with a second threshold power value if the ratio of the power levels of the first and second control signals exceeds the threshold ratio; and generating an intrusion alarm signal, if the first signal is below the first threshold power value and the second signal is below the second threshold power value.

### CROSS-REFERENCE TO RELATED APPLICATIONS

This application claims priority to U.S. Provisional Application No. 62/060,942, filed Oct. 7, 2014, which is hereby incorporated by reference in its entirety.

### BACKGROUND

Data transmission on fiber optic cables was once considered as one of the most secure types of transmission. However, interception by an intruder, e.g., intrusion in the fiber optic network and extraction of information from the fibers carrying optical signals is possible. Interception can happen when part of the optical signal carrying the data is diverted to an unauthorized detector, for example, by introducing a macro-bend in the optical fiber. A macro-bend is a bend in the optical fiber with a radius much larger than the radius of the optical fiber core.

Because of the nature of signal transmission through the optical fiber, a bend on the optical fiber can reduce the total internal reflection of the optical signal in the fiber core. This can result in leakage of the optical signal through the cladding out of the fiber. If an intruder places a detector adjacent to the macro-bend, then the detector can be used to receive the data without authorization.

To avoid unauthorized interception of optical signals, optical fiber systems implement different forms of “intrusion detection” systems to counter this potential security threat. For example, one existing technique for providing additional data security includes initiating an alarm if the magnitude of a received signal power at a channel wavelength of the optical fiber system is below a specified threshold level.

Monitoring the received power is a relatively inexpensive technique. However, it may not provide adequate security. First, the bend-induced power loss may be very low, for example, a fraction of a decibel (dB), and therefore may not be detected, if it is lower than the threshold level. Alternatively, this technique may result in numerous “false” intrusion detections, if the threshold level is set very low, and can set off an alarm even for non-intrusive loss of signal power. A lot of false detections can happen because of signal power fluctuations that occur naturally, rather than because of the artificial fiber bending for illegal data extraction purposes.

### BRIEF DESCRIPTION OF THE DRAWINGS

FIG. 1 shows the macro-bend loss for three signals with different wavelengths, for different values of bend radii for standard SMF-28 fiber.

FIG. 2 illustrates the relative Signal Loss for wavelengths corresponding to C-Band boundaries for different bend radii values.

FIG. 3 shows a first embodiment of an intrusion detection system according to aspects of the present disclosure.

FIG. 4 shows a second embodiment of an intrusion detection system according to aspects of the present disclosure.

FIG. 5 shows a third embodiment of an intrusion detection system according to aspects of the present disclosure.

### SUMMARY

Systems and methods for detection of intrusion in optical fibers are disclosed. Multiple optical channels are utilized to transmit payload data signals. In addition, optical channels having the wavelengths that are at or exceed the outer limits of the range of wavelengths used for the payload data signals are utilized to transmit control signals. The control signals are modulated and multiplexed with payload data signals and are sent to a remote location through one or more optical fibers. Intrusion in such optical fibers can be detected upon receipt at the remote location with the systems and methods described herein.

A method for detecting intrusions in optical fibers can include receiving the multiplexed signals. The method includes demultiplexing and demodulating the received signals into separate payload data signals and control signals. The method can further include measuring the ratio of power levels of the control signals (i.e., at the optical channels having the lowest and highest wavelengths) and comparing the measured ratio against a predetermined threshold ratio. If the measured value is more than the predetermined threshold ratio, then the method can include comparing the power levels of the control signals against predefined values and when both of them are lower compared to those predefined values, generating an alarm signal to identify an instance of intrusion. The disclosed methods can include measuring the ratio of power levels of the control signals on every time slot. In the disclosed methods, the predetermined threshold ratio can be calculated based on a power ratio standard deviation.

A system for detecting intrusions in optical fibers can include demultiplexer for demultiplexing received signals into payload data signals and control signals and demodulators for demodulating those signals. The system can further include amplifiers for amplifying the demodulated signals and comparators for comparing the power levels of the received demultiplexed control signals. The system can further include logic circuitry for generating an alarm signal the result of comparing the power levels of the control signals indicates an instance of intrusion.

In one embodiment, a method for detecting intrusions in optical fibers can include receiving an optical signal; demultiplexing the received optical signal into one or more payload data signals, a first control signal, and a second control signal; comparing a ratio of power levels of the first and second control signals with a threshold ratio; comparing the power level of the control first signal with a first threshold power value and the second control signal with a second threshold power value if the ratio of the power levels of the first and second control signals exceeds the threshold ratio; and generating an intrusion alarm signal, if the first signal is below the first threshold power value and the second signal is below the second threshold power value.

In accordance with other aspects of this embodiment, the method can include demodulating the first and second control signals. The first control signal can have a higher wavelength than the one or more payload data signals and the second control signal can have a lower wavelength than the one or more payload data signals

In accordance with other aspects of this embodiment, the threshold ratio can be predetermined based on a standard deviation of control signal power levels.

In accordance with another embodiment, a system for detecting intrusions in optical fibers can include a demultiplexer, comparator, and logic circuitry configured to carry out any and all of the steps in the above described method.

In accordance with another embodiment, a method for detecting intrusions at optical fibers can include receiving, at a first physical location an optical signal over optical fibers from a second physical location; demultiplexing, at the first physical location, the optical signal into a first control signal, a second control signal, and one or more data payload signals; comparing, at the first physical location, a ratio of the power levels of the first and second control signals at the first physical location against a first threshold ratio; and generating an intrusion alarm signal if the ratio of power levels of the first and second signals exceeds the first threshold ratio.

In accordance with other aspects of this embodiment, the method can include receiving the optical signal over optical fibers at a third physical location; at the third physical location, demultiplexing the optical signal into the first control signal, the second control signal, and the one or more data payload signals; comparing a ratio of the power levels of the first and second control signals at the third physical location against a second threshold ratio; and generating an intrusion alarm signal if the ratio of power levels of the first and second control signals exceeds the second threshold ratio.

In accordance with other aspects of this embodiment, the method can further include generating a signal identifying the physical detection where an intrusion is detected, if the intrusion alarm signal is generated.

In accordance with other aspects of this embodiment, the first physical location can be an outdoor location and the second physical location can be an indoor location.

In accordance with another embodiment, a system for detecting intrusions in optical fibers can include receivers, demultiplexers, comparators, and logic circuitry configured to carry out any and all of the steps in the above described method.

In accordance with another embodiment, a method for detecting intrusions at optical fibers can include receiving an optical signal; demultiplexing the received signal into at least a first channel and a second channel; detecting a plurality of data frames in the received signal, each data frame including a header portion distinct from a data payload portion; generating a first average power level for the first channel determined over a plurality of header portions; generating a second average power level for the second channel determined over a plurality of header portions; comparing a ratio of the first average power level and the second average power with a threshold ratio; and generating an intrusion alarm signal, if the ratio exceeds the threshold ratio.

In accordance with other aspects of this embodiment, the method can further include determining time intervals associated with the plurality of header portions; and generating a synchronization signal representing the determined time intervals.

In accordance with another embodiment, a system for detecting intrusions in optical fibers can include a demultiplexer, a deframer, a power level meter, a comparator, and logic circuitry configured to carry out any and all of the steps in the above described method.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### DETAILED DESCRIPTION

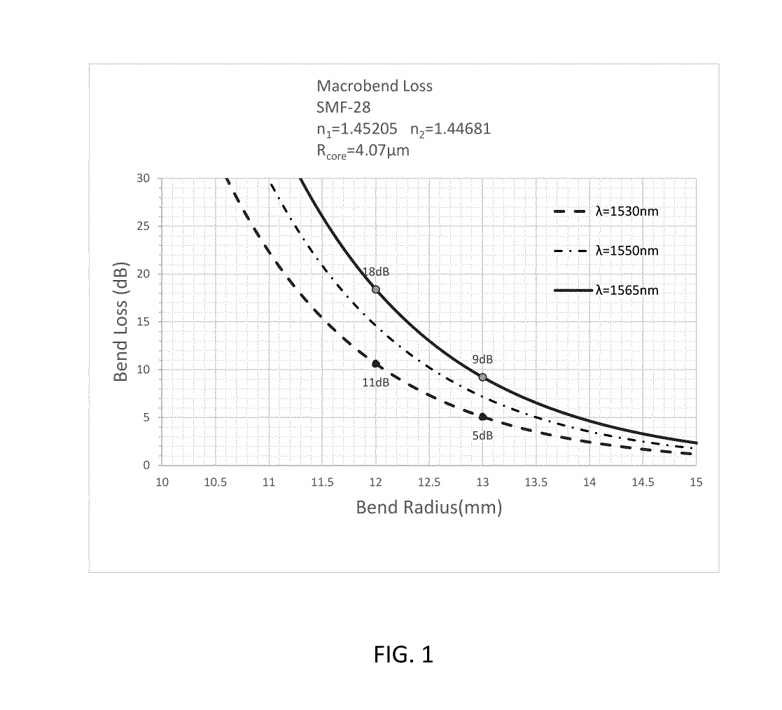

As shown in FIG. 1, in single mode optical fibers (assuming bend radius is much greater than the fiber core radius), optical signals with longer wavelengths suffer greater macro-bend loss than signals with shorter wavelengths. FIG. 1 shows the macro-bend loss for three signals with different wavelengths, for different values of bend radii for standard SMF-28 fiber. Boundary wavelengths λ=1530 nm and λ=1565 nm correspond to Dense Wavelength Division Multiplexing (“DWDM”) infrared fiber optic communications C-band. As shown, the optical signal with a wavelength of λ=1565 nm suffers greater loss than the other two signals with shorter wavelengths.

The disclosed systems and methods for intrusion detection in optical fiber systems utilize this principle to distinguish random variations of optical signal power from an actual intrusion. The random variations can result, for example, from fluctuations of optical signal power sources or variations in environmental humidity or temperature or fiber stress.

According to aspects of the present disclosure, a method for detecting intrusions in optical fiber systems uses at least two signals with different wavelengths in the infrared fiber optic communications C-band range. The method adjusts the power of the transmitted optical signals that have a preselected wavelength, such that, at a first location on an optical fiber segment, the received signal power of the optical signals is greater than a minimum detected signal power.

For example, the method can select two signals with boundary wavelengths in the C-band range, such as signals with wavelengths λ₁=1530 nm and λ_{N}=1565 nm. During an calibration phase, which lasts for example, a predefined time slot T₀, the method calculates 4 parameters:

1. Average power P₁^{T}^{₀}= [symbol] P₁ [symbol] _{T}_{₀}
2. Average power P_{N}^{T}^{₀}= [symbol] P_{N} [symbol] _{T}_{₀}
3. The average power ratio of both signals; R_{T}_{₀}= [symbol] ρ [symbol] _{T}_{₀} where

$$ρ ( t ) = 10 \cdot {log}_{10} ( \frac{{P}_{1} ( t )}{{P}_{N} ( t )} ) ;$$

and
4. The standard deviation

$${Δ}_{{T}_{0}} = \sqrt{{〈 {( ρ - {R}_{{T}_{0}} )}^{2} 〉}_{{T}_{0}}}$$

of the average power ratio of both signals.

Parameters P₁, P_{N} and R, can be calculated at every time slot, while Δ_{T}_{₀} can be measured only during calibration.

In the equations above, “P₁” and “P_{N}” are the measured optical power values that correspond to the signals with wavelengths λ₁ and P_{N}, respectively. The operation [symbol] . . . [symbol] _{T}_{₀} denotes time averaging along the calibration phase of duration T₀.

Because of the time averaging, the value of the average power ratio “R_{T},” measured at different time intervals, has a weak dependency on fast fluctuations of the signal and mainly depends on fiber bending or another fiber deformation that may indicate intrusion.

According to aspects of the present disclosure, typical slot (Tₒ) values can range from several seconds up to several minutes. Such averaging base provides filtering out fluctuations of the optical signal source power, as well as random mechanical fiber tensions or deformation. Those fluctuations usually have an acoustic nature, and, therefore, have characteristic frequencies from several Hz to several kHz or characteristic periods from several milliseconds to hundreds milliseconds.

FIG. 1 illustrates that macro bend loses increase rapidly with decreasing bend radius values. FIG. 1 also illustrates that macro bend loses for signals with longer wavelengths increase faster than losses for signals with shorter wavelengths. This loss characteristics is specific to all known types of intrusion attacks. The disclosed systems and methods exploit differential measurements of power losses that correspond to different wavelength channels. Differential measurements can increase the sensitivity of detecting possible attacks, and, at the same time, decrease the probability of “false” alarms of intrusion attacks because the method exploits two characteristic, i.e., bend radius dependence and wavelength dependence of losses specific to each intrusion.

Specifically, the method preferably uses boundary wavelengths to improve sensitivity to possible intrusions, while keeping the probability of “false” intrusion detection low. Specifically, using boundary wavelengths results in a greater wavelength difference, which in turn corresponds to greater power loss ratio for the same bend radius. “False” intrusion indication is identified when the signal power for both wavelengths degrades “uniformly” due, for example, to cable mechanical stress and not bending.

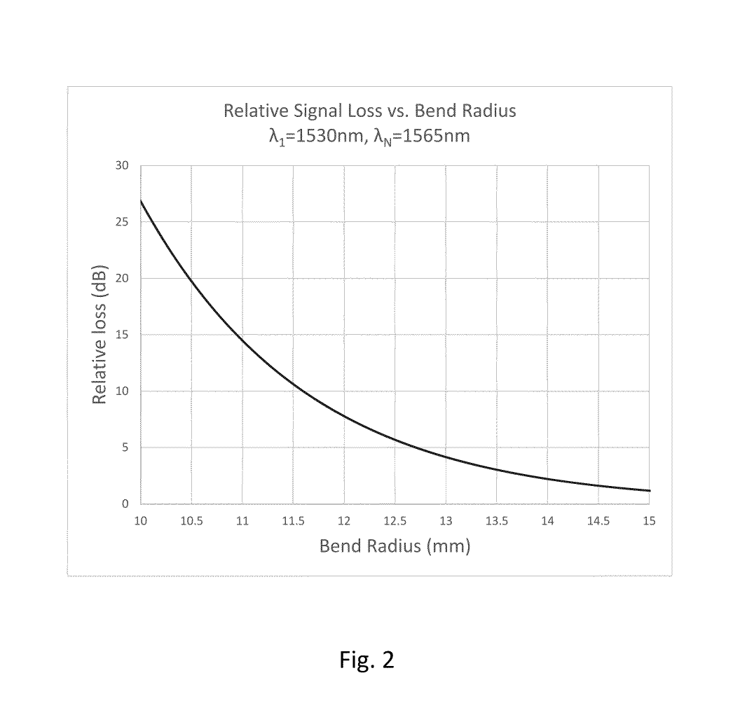

FIG. 2 illustrates the relative Signal Loss for different bend radii values, for the boundary wavelengths λ₁=1530 nm and λ_{N}=1565, which correspond to C-Band boundaries.

The average power ratio “R” is expected to have a similar time dependency in the case of equalized power optical sources corresponding to both wavelengths (in this case R_{T}_{₀}≈0) and differ by a constant shift in the case of unbalanced sources. “Equalized” or “balanced” sources are sources that radiate the same optical power. When the source power is R_{T}_{₀}=0 dB (logarithmic scale). An approximation of the formula presented above may assume that even in the case of equalized sources and the absence of intrusion, any optical cable may have small initial imbalance of different wavelengths propagation conditions, which may not be related to an intrusion attack. For example, the initial imbalance may be the result of a possible initial deformation of cable, initial bends of cable, or the connectors.

When the power sources are not balanced, the average power ratio has a non-zero value (R_{T}_{₀}≠0) and may be of any sign, positive or negative. Accordingly, shifts by its value are all further calculated by subtracting these values from the power ration (R-values).

As illustrated in FIG. 2, taking into consideration the characteristics of the macro-bend loss, a potential intrusion can lead to sufficient increase of the ratio of average powers, “ρ” before the intrusion session. An intrusion, i.e., an act of illegal data interception, requires that a portion of the optical power of the transferring signal is intercepted or stolen, which is then demodulated and decoded. This can be accomplished, for example, by stripping the fiber cladding and bending the fiber. Part of the optical power is directed away from the fiber and can be detected by the intruder and be demodulated. For a successful detection, the power level of the signal that is being directed away must be at least higher than the noise level. Assuming that, without an intrusion, the standard deviation of the noise level is Δ_{T}_{₀}, and that noise has a Gaussian characteristic, if the standard deviation of the noise level exceeds a value of 3Δ_{T}_{₀}, then with high probability, the change in the standard deviation value was not a result of a random stochastic noise, but rather the result on an intrusion.

For each time slot, the disclosed method calculates the average power ratio of both signals, and simultaneously checks whether the average power ratio “R_{Tn}” of the current slot is greater than the average power ratio “R_{Tn-1}” that corresponds to the previous time slot, i.e., a predetermined reference value. Specifically, the method checks whether the average power ratio of the current slot is greater than a previous average power ratio by a predefined threshold measured in units of power ratio standard deviation “Δ_{T}_{₀}”. For example, the predefined threshold can correspond to three times the value of standard deviation or 3Δ_{T}_{₀}. However, other predefined thresholds can be utilized. The predefined threshold can be sufficient to distinguish random fluctuations from intrusions caused by fiber bends. Therefore, if the measured power ratio at a particular time slot is greater than the power ratio at a previous time slot, by a value of more than three times the standard deviation of the power ratio of both signals (R_{T}_{ₙ}>R_{T}_{ₙ₊₁}+3Δ_{T}_{₀}), then the method can generate an intrusion alarm signal if both power values are strongly decreasing against previous measure. Otherwise, the method updates the average power ratio reference values

$${R}_{{T}_{n + 1}} = \frac{{R}_{{T}_{n}} + {aR}_{{T}_{n + 1}}}{1 + a} ;$$

$$a ≪ 1.$$

The system continues to perform the same steps for the next time slot. Parameter α is constant, predefined and

$$0 < α < \frac{T}{{T}_{0}}$$

where T is the time interval of current averaging, and T₀ is the calibration time interval. The difference between them is predefined and in some embodiments may exceed several orders of magnitude, for example, from one to three orders of magnitude. Under embodiments of the present disclosure the standard deviation Δ_{T} corresponds to the standard deviation of a previous calibration time slot. The calibration can happen upon operator request, for example, if the system generates too much “false” intrusion signals.

### Embodiment #1

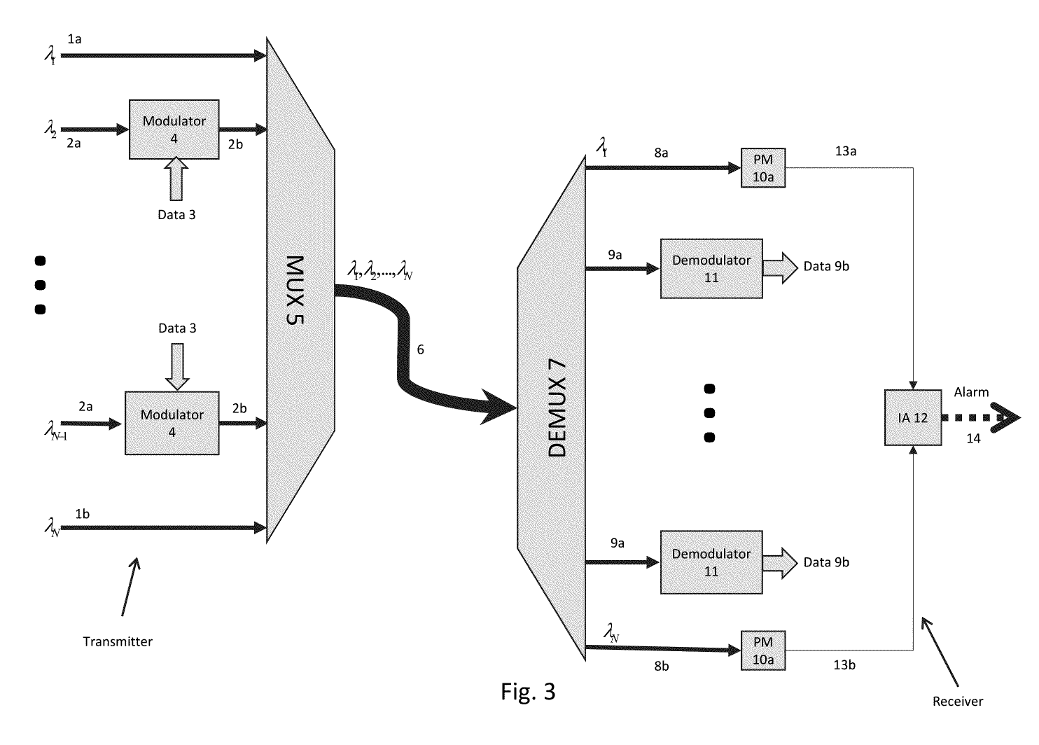

An exemplary intrusion detection system in an optical fiber that uses two signals with boundary wavelengths detection is illustrated in FIG. 3. On the Transmitter side, the optical channels λ₁, λ_{N} carry input intrusion detection control signals 1a and 1b, as discussed above. They can be generated as constant optical power single mode fiber signals. For example, optical channels λ₁, λ_{N} can carry 1530 nm and 1565 nm control signals. On the Receiver side, these control signals can be used to provide the relative power measurement and intrusion analysis as discussed above.

More specifically, as shown in FIG. 3, input intrusion detection control signals 1a and 1b are provided in optical channels λ₁, λ_{N}. In optical channels λ₂ through λ_{N-1}, constant optical power single mode fiber input 2a are provided and modulated with input data 3 (e.g., electronic data) using modulator 4 (e.g., electro-optical modulators) to provide modulated optical payload data signal 2b. The modulated optical payload data signal 2b and control signals 1a and 1b can be multiplexed using optical multiplexor MUX 5 to provide a single mode fiber channel 6. The single mode fiber channel 6 may potentially include macro bend losses that can be detected at the receiver end.

At the receiver end, using optical demultiplexer 7, the signals received from the single mode fiber channel 6 can be demultiplexed into received optical payload signals 9a in optical channels λ₂ through λ_{N-1} and intrusion control signal 8a and 8b in optical channels λ₁ and λ_{N}, respectively. In the optical channels λ₂ through λ_{N-1}, received optical payload signals 9a are provided to demodulator 11 to obtain payload data signal 9b. In optical channels λ₁ and λ_{N}, control signals 8a and 8b are sent to optical power meter 10a. Thereafter, measured optical power data 13a and 13b on optical channels λ₁ and λ_{N}, respectively, can be sent to the intrusion control logic 12 where the intensity ratio between the measured optical power data in the λ₁ and λ_{N} optical channels can be measured.

Then, if a pre-determined threshold value is exceeded, such as the value of R_{T}_{₁}>R_{T}_{₀}+3Δ_{T}_{₀}, the system can generate an intrusion alarm signal 14. If not, the system can update the reference average power ratio and values R_{T}_{₀}=R_{T}_{₁} and repeat the same steps as described above in the next time slot.

### Embodiment #2

In other embodiments, intrusion detection can be provided using a control signal, payload signal, and a form of division multiplexing, such as time division multiplexing or frequency division multiplexing. This embodiment can allow utilization of λ₁ and λ_{N} optical channels for both data transfer and intrusion detection with relatively low penalty.

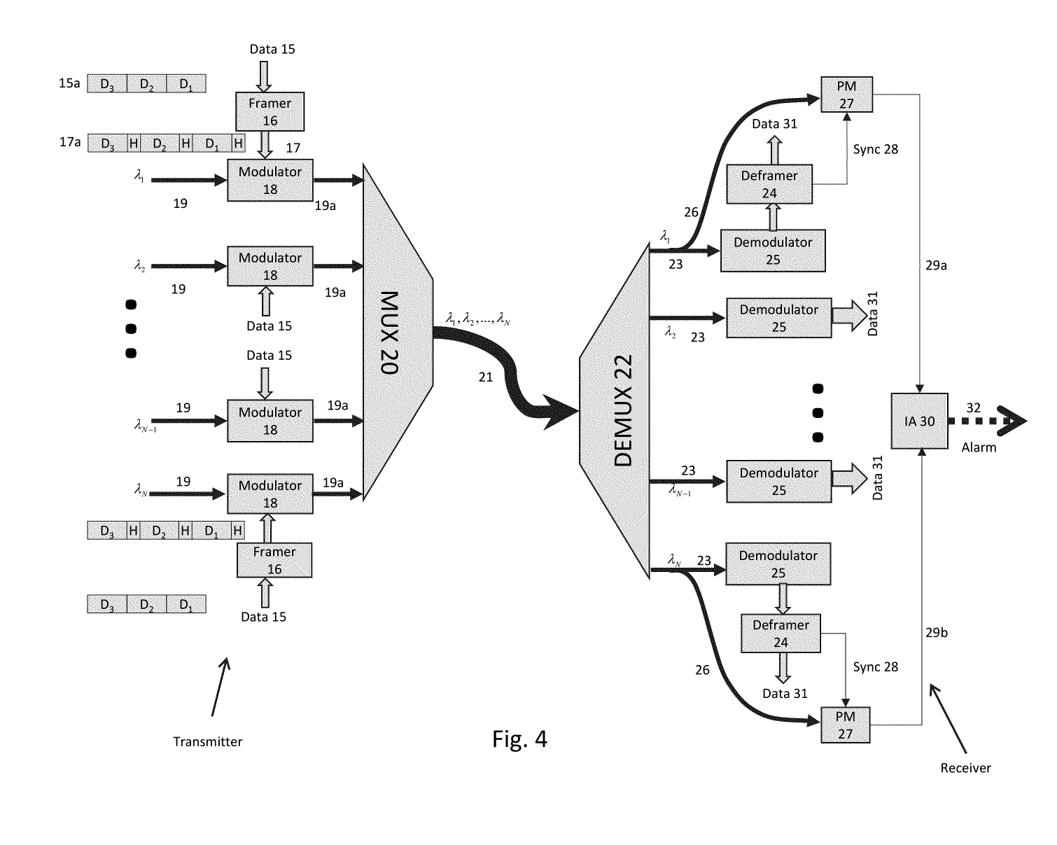

As shown in FIG. 4, input data 15 (e.g., electronic data) is received in optical channels λ₁ through λ_{N}. The input data (e.g., electronic data) 15 can contain sequential input data frames, as schematically illustrated in 15a. The sequential input data frames can define a data frame of fixed length (duration). For λ₁ and λ_{N} optical channels, a framer 16 can insert a constant duration and constant average value header between each data frame for use in intrusion detection. The header can be short (as compared to the length of each data frame) and have a fixed pattern. As shown, sequential input data frames with header structure 17a results. These combined sequential input data frames with header structure 17a can be modulated using modulator 18 (e.g., electro-optical modulators) to provide modulated optical signal 19a. Moreover, other optical channels λ₂ to λ_{N-1} can receive constant optical power single mode fiber inputs 19, along with data 15 and modulated using modulator 18 to provide modulated optical signal 19a. The modulated optical signals 19a can be multiplexed using optical multiplexor MUX 20 to provide a single mode fiber channel 21. The single mode fiber channel 21 may potentially include macro bend losses that can be detected at the receiver end.

At the receiver end, the signals received from the single mode fiber channel 21 can be demultiplexed using optical demultiplexer 22 into separate single mode optical channels λ₁ through λ_{N} 23. In the optical channels λ₁ and λ_{N}, the signal can be split using an optical splitter 26. Accordingly, a portion of the signal in optical channels λ₁ and λ_{N} is sent to an optical power meter 27 while a portion of the signal is sent to demodulator 25 (e.g., electro-optical demodulator) to be demodulated. The demodulated signal is then sent to the deframer 24, which extracts and separates out the payload data 31 from the header information. The deframer 24 further generates a synchronization signal 28 to start/stop measurement of optical power at the power meter 27, which detects and measures the optical power that is synchronized to the deframer 24 by the synchronization signal 28. Thereafter, measured optical power data 29a and 29b from optical channels λ₁ and λ_{N}, respectively, can be sent to the intrusion control logic 30 where the header intensity ratio between the headers in the optical channels λ₁ and λ_{N} can be measured on a per frame basis.

Then, the average of the intensity levels ratio along many (e.g., M) frames (super-frame) can be calculated as shown below:

$${R}_{k} = {〈 ρ 〉}_{k} ≡ \frac{1}{N} {\sum }_{j = kN}^{k ( M + 1 )} ρ ( j ) , \\ where$$

$$k = 1 , 2 , … , ;$$

$${P}_{L} = {〈 {p}_{L} 〉}_{k} = \frac{1}{N} {\sum }_{j = kN}^{k ( M + 1 )} {p}_{L} ( j ) , \\ where$$

$$k = 1 , 2 , … , \\ and$$

$$L = 1 , N ;$$

Here [symbol] [symbol] ₖ denotes averaging along k-th superframe and p_{L}(j) denotes power value measured at j-th frame, where j represents the index of frame and P₁ and P_{N} represent the mean levels of header's signal corresponding to λ₁ and λ_{N}.

Then, if at some super frame (for example, the k-th), a pre-determined threshold value is exceeded, such as the value of Rₖ>Rₖ₋₁+3Δ (Rₖ₋₁, e.g., saved from previous super-frame), then intrusion alarm signal 32 can be sent to both the transmitter and the receiver at next frame time. Under the present embodiment, the method of detecting intrusion uses indexes instead of time due to the discrete character of the measurements.

While a time division multiplexing of data is illustrated in FIG. 4, frequency division multiplexing of data can also be carried out. Regardless which embodiment is utilized, influence of payload signal on fluctuation of optical power measured for intrusion detection and determination of intrusion can be readily carried out.

### Embodiment #3

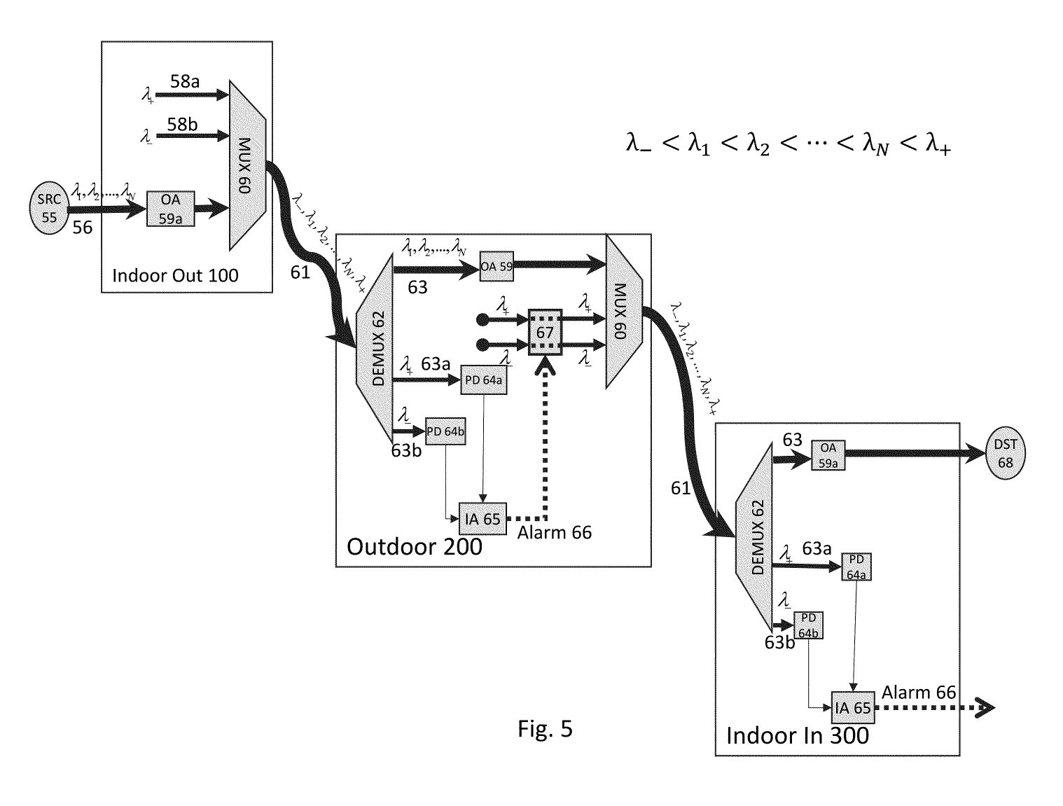

In certain embodiments, intrusion detection system can include one indoor output unit 100, one indoor input unit 300 and (optionally) one or more outdoor units 200. FIG. 5 shows an exemplary intrusion detection system, where intrusion detection is carried out at an outdoor location 200 and at an indoor input location 300. Under alternative aspects of the present disclosure, indoor connections do not suffer from intrusion or have some other mechanism of detecting intrusions.

As shown in FIG. 5, the exemplary intrusion detection system utilizes two control signals with wavelengths that are outside of the wavelengths utilized for payload data signals delivery. For example, the intrusion detection system includes at least two coherent optical sources with wavelength (Δ₋) chosen from S-band (1460-1530 nm, preferably close to its upper limit) and (λ₊) from L-band (1565-1625 nm, preferably close to its upper limit). Specifically, one wavelength can be below the optical amplifier's lowest wavelength (Δ₋) and the other wavelength can be above its upper wavelength (λ₊). In FIG. 5, these are shown as constant optical power single mode fiber input intrusion detection control signals 58a and 58b having wavelengths κ₊ and λ₋, respectively, where λ₋<λ₁<λ₂< . . . <λ_{N}<λ₊.

At indoor output location 100, payload data signal 56 can be delivered on optical channels λ₁ through λ_{N} from a source 55 using any type of modulation and multiplexing (e.g., wavelength division multiplexing system). The payload data signal 56 is optionally amplified with an optical amplifier 59a. The payload data signal 56 and control signals 58a and 58b can be multiplexed together using multiplexer 60. The multiplexed signal is transmitted to an outdoor location 200 as a single mode fiber channel 61. In certain embodiments, macro bend losses can occur during transmission.

In FIG. 5, intrusion detection is not carried out at indoor output location 100. However, if desired, any of the embodiments discussed herein can be utilized to carry out an intrusion detection at indoor output location 100.

At the outdoor location 200, the signals received from the single mode fiber channel 61 can be demultiplexed using optical demultiplexer 62 into received optical payload signals 63 in optical channels λ₁ through λ_{N} and output intrusion control signals 63a and 63b in optical channels λ₊ and λ₋, respectively. In the optical channels λ₁ through λ_{N}, received optical payload signals 63 are provided to optical amplifier 59, where the amplified optical signal is provided to multiplexor 60. In optical channels λ₊ and λ₋, control signals 63a and 63b are sent to optical power meters 64a and 64b, respectively. Thereafter, measured optical power data can be sent to the intrusion control logic 65 where the intensity ratio between the optical power data in the λ₁ and λ_{N} optical channels can be measured as described above.

Then, if a pre-determined threshold value is exceeded, such as the value of R_{T}_{₁}>R_{T}_{₀}+3Δ_{T}_{₀}, the system can generate an intrusion alarm signal 66, which can be sent to an optical on/off switch 67. As shown, the optical on/off switch 67 can be provided with additional λ₋ and λ₊ coherent sources that can be utilized for further intrusion detection in additional outdoor locations 200 or in the final indoor input location 300. If no alarm signal 66 is generated, the system can update the reference average power ratio and values as described above and repeat the same steps as described above in the next time slot.

In certain embodiments, the intrusion alarm signal 66 can control the optical on/off switch 67 of λ₋, Δ₊, such that adding, or even generating, of the λ₋, λ₊ signals at optical multiplexor 60 is halted. In certain embodiments, the alarm signal 66 can even prevent generation of the λ₋, λ₊ signals altogether. If no alarm signal 66 is generated, then all 3 signals are multiplexed by multiplexor 60 into one single mode fiber for transmission to indoor input location 300 or next outdoor intrusion detection unit (not shown).

Upon receipt of the multiplexed signal at the indoor input location 300 through a single mode fiber channel 61, similar intrusion detection scheme as explained with respect to the outdoor location 200 is carried out, where the payload data signal from optical amplifier 59a can be delivered to the destination node 68.

In some embodiments, an additional control signal can be added, such as one or more signals with wavelength λ₋⁻<λ₋ (which is less sensitive to intrusion than λ₋, λ₊). This additional optical carrier may be used to transfer from node to node additional information concerning an anticipated attack, such as identification of the location (e.g., outdoor location 200 or indoor input location 300, etc.) where the intrusion occurred. Some additional features may include adding an λ₋⁻ optical source with corresponding modulating equipment to use this optical channel as an additional carrier to transmit any support information within an appropriate segment of the optical cable.

1. A method for detecting intrusions in optical fibers, comprising:
receiving an optical signal;
demultiplexing the received optical signal into one or more payload data signals, a first control signal, and a second control signal;
comparing a ratio of power levels of the first and second control signals with a threshold ratio;
comparing the power level of the control first signal with a first threshold power value and the second control signal with a second threshold power value if the ratio of the power levels of the first and second control signals exceeds the threshold ratio; and
generating an intrusion alarm signal, if the first signal is below the first threshold power value and the second signal is below the second threshold power value.

2. The method of claim 1, further comprising demodulating the first and second control signals;
wherein the first control signal has a higher wavelength than the one or more payload data signals and the second control signal has a lower wavelength than the one or more payload data signals.

3. The method of claim 1, wherein the threshold ratio is predetermined based on a standard deviation of control signal power levels.

4. A system for detecting intrusions in optical fibers, comprising:
a demultiplexer configured to demultiplex a received optical signal into one or more payload data signals, a first control signal, and a second control signal;
a comparator configured to:
compare a ratio of power levels of the first and second control signals with a threshold ratio, and
compare the power level of the control first signal with a first threshold power value and the second control signal with a second threshold power value if the ratio of the power levels of the first and second control signals exceeds the threshold ratio; and
logic circuitry configured to generate an alarm signal, if the first signal is below the first threshold power value and the second signal is below the second threshold power value.

5. The system of claim 4, further comprising a demodulator configured to demodulate the first and second control signals, wherein the comparator is further configured to receive and compare the power levels of the demodulated first and second control signals.

6. The system of claim 5, further comprising an amplifier configured to amplify the demodulated first and second control signals, wherein the comparator is further configured to receive and compare the power levels of the demodulated, amplified first and second control signals.

7. A method for detecting intrusions at optical fibers, comprising:
receiving, at a first physical location an optical signal over optical fibers from a second physical location;
demultiplexing, at the first physical location, the optical signal into a first control signal, a second control signal, and one or more data payload signals;
comparing, at the first physical location, a ratio of the power levels of the first and second control signals at the first physical location against a first threshold ratio; and
generating an intrusion alarm signal if the ratio of power levels of the first and second signals exceeds the first threshold ratio.

8. The method of claim 7, further comprising:
receiving the optical signal over optical fibers at a third physical location;
at the third physical location, demultiplexing the optical signal into the first control signal, the second control signal, and the one or more data payload signals;
comparing a ratio of the power levels of the first and second control signals at the third physical location against a second threshold ratio; and
generating an intrusion alarm signal if the ratio of power levels of the first and second control signals exceeds the second threshold ratio.

9. The method of claim 8, further comprising generating a signal identifying the physical detection where an intrusion is detected, if the intrusion alarm signal is generated.

10. The method of claim 8, wherein the first physical location is an outdoor location and the second physical location is an indoor location.

11. A system for detecting intrusions in optical fibers, comprising:
a first receiver, positioned at a first physical location, configured to receive an optical signal over optical fibers from a second physical location;
a first demultiplexer, positioned at the first physical location, configured to demultiplex the optical signal into a first control signal, a second control signal, and one or more data payload signals;
a first comparator, positioned at the first physical location, configured to compare, a ratio of the power levels of the first and second control signals at the first physical location against a first threshold ratio; and
logic circuitry configured to generate an intrusion alarm signal if the ratio of power levels of the first and second signals exceeds the first threshold ratio.

12. The system of claim 11, further comprising:
a second receiver, positioned at a third location, configured to receive the optical signal over optical fibers at a third physical location;
a second demultiplexer, positioned at the third location, configured to demultiplex the optical signal into the first control signal, the second control signal, and the one or more data payload signals;
a second comparator, positioned at the third location, configured to compare a ratio of the power levels of the first and second control signals at the third physical location against a second threshold ratio; and
logic circuitry configured to generate an intrusion alarm signal if the ratio of power levels of the first and second control signals exceeds the second threshold ratio.

13. The system of claim 11, further comprising logic circuitry configured to generate a signal identifying the physical detection where an intrusion is detected, if the intrusion alarm signal is generated.

14. The system of claim 11, wherein the first physical location is an outdoor location and the second physical location is an indoor location.

15. A method for detecting intrusions in optical fibers, comprising:
receiving an optical signal;
demultiplexing the received signal into at least a first channel and a second channel;
detecting a plurality of data frames in the received signal, each data frame including a header portion distinct from a data payload portion;
generating a first average power level for the first channel determined over a plurality of header portions;
generating a second average power level for the second channel determined over a plurality of header portions;
comparing a ratio of the first average power level and the second average power with a threshold ratio; and
generating an intrusion alarm signal, if the ratio exceeds the threshold ratio.

16. The method of claim 15, further comprising:
determining time intervals associated with the plurality of header portions; and
generating a synchronization signal representing the determined time intervals.

17. A system for detecting intrusions in optical fibers, comprising:
a demultiplexer configured to demultiplex a received optical signal into at least a first channel and a second channel;
a deframer configured to detect a plurality of data frames in the received signal, each data frame including a header portion distinct from a data payload portion;
a power level meter configured to:
generate a first average power level for the first channel determined over a plurality of header portions, and
generate a second average power level for the second channel determined over a plurality of header portions;
a comparator configured to compare a ratio of the first average power level and the second average power with a threshold ratio; and
logic circuitry configured to generate intrusion alarm signal, if the ratio exceeds the threshold ratio.

18. The system of claim 17, wherein the deframer is further configured to:
determine time intervals associated with the plurality of header portions; and
generate a synchronization signal representing the determined time intervals.
